(19) United States
(12) Patent Application Publication
(10) Pub. No.: US 2025/0014809 A1
(43) Pub. Date: Jan. 9, 2025

(54) COIL ELECTRONIC COMPONENT

(71) Applicant: SAMSUNG ELECTRO-MECHANICS CO., LTD., Suwon-si (KR)

(72) Inventors: Tae Hyun Kim, Suwon-si (KR); Donghwan Lee, Suwon-si (KR); Daeki Lim, Suwon-si (KR); Boumseock KIM, Suwon-si (KR)

(73) Assignee: SAMSUNG ELECTRO-MECHANICS CO., LTD., Suwon-si (KR)

(21) Appl. No.: 18/634,409

(22) Filed: Apr. 12, 2024

(30) Foreign Application Priority Data
Jul. 5, 2023 (KR) 10-2023-0087166

(51) Int. Cl. H01F 27/30; H01F 27/28; H01F 27/29

(52) U.S. Cl. CPC H01F 27/306; H01F 27/2852; H01F 27/292

(57) ABSTRACT

A coil electronic component includes: a first coil; a second coil spaced apart from the first coil; an intermediate layer disposed to extend from a first region between a first core (hollow space) of the first coil and a second core of the second coil to a second region between the first coil and the second coil; and a magnetic body surrounding the first coil, the second coil, and the intermediate layer, wherein the intermediate layer has a smaller permeability than that of the magnetic body.

### CROSS-REFERENCE TO RELATED APPLICATION

This application claims priority to and the benefit of Korean Patent Application No. 10-2023-0087166 filed in the Korean Intellectual Property Office on Jul. 5, 2023, the entire contents of which are incorporated herein by reference.

### BACKGROUND

### Technical Field

The present disclosure relates to a coil electronic component.

### Description of the Related Art

Recently, as functions of mobile devices diversify, power consumption increases. Accordingly, in order to increase a time for which a battery in a mobile device is usable, a coil electronic component with low loss and excellent efficiency is employed around a power management integrated circuit (PMIC).

In a case where a coil electronic component has a coupled inductor structure in which a first coil and a second coil are arranged vertically, there is a need for a method for easily adjusting a coefficient of coupling (K) while securing a high inductance.

In addition, it may be necessary to keep the spacing between the first and second coils constant by preventing or minimizing the first and second coils from tilting relative to each other.

### SUMMARY

The present disclosure attempts to provide a coil electronic component having a coupled inductor structure capable of easily adjusting a coefficient of coupling while securing a high inductance.

In another aspect, the present disclosure attempts to provide a coil electronic component having a coupled inductor structure capable of preventing vertically arranged coils from tilting relative to each other and keeping the spacing between the coils constant.

However, the problems to be solved by the present embodiments are not limited to the above-described problems and may variously extend within the scope of the technical idea included in the present embodiments.

An embodiment of the present disclosure provides a coil electronic component including: a first coil including a first core; a second coil spaced apart from the first coil, the second coil including a second core; an intermediate layer disposed from a first region between the first core and the second core to a second region between the first coil and the second coil; and a magnetic body surrounding the first coil, the second coil, and the intermediate layer, wherein the intermediate layer has a smaller permeability than that of the magnetic body.

The intermediate layer may be in contact with the first coil and the second coil.

The intermediate layer may be spaced apart from an outer edge of the second region.

A thickness of the intermediate layer in the first region may be the same as a thickness of the intermediate layer in the second region.

The intermediate layer may extend from the first region to a portion of the first core.

The intermediate layer may extend from the first region to a portion of the second core.

The intermediate layer may extend from the first region to a portion of the first core, and the intermediate layer may extend from the first region to a portion of the second core.

The second region may include an inner region and an outer region in contact with the inner region, the intermediate layer is disposed in the inner region, and the magnetic body is disposed in the outer region.

The coil electronic component may further include a support disposed in the second region and in contact with the first coil and the second coil.

The support may be spaced apart from the intermediate layer.

The support may be in contact with the intermediate layer.

The support may include a magnetic material, an epoxy, or a non-magnetic material.

The first coil may further include a first lead-out portion and a second lead-out portion, and the second coil may further include a third lead-out portion and a fourth lead-out portion. The coil electronic component may further include: a first external electrode disposed outside the magnetic body and connected to the first lead-out portion; a second external electrode disposed outside the magnetic body and connected to the second lead-out portion; a third external electrode disposed outside the magnetic body and connected to the third lead-out portion; and a fourth external electrode disposed outside the magnetic body and connected to the fourth lead-out portion.

The first coil may further include a first wound coil, and the second coil may further include a second wound coil.

The first coil may further include: a first support member having a first surface and a second surface facing each other; a first coil pattern disposed on the first surface of the first support member; a second coil pattern disposed on the second surface of the first support member; and a first via passing through the first support member to connect the first coil pattern and the second coil pattern, and the second coil may include: a second support member having a third surface and a fourth surface facing each other; a third coil pattern disposed on the third surface of the second support member; a fourth coil pattern disposed on the fourth surface of the second support member; and a second via passing through the second support member to connect the third coil pattern and the fourth coil pattern.

The intermediate layer may be disposed to extend to a portion of the second region.

An insulating film may be disposed on a surface of the first coil and a surface of the second coil.

An embodiment of the present disclosure provides a coil electronic component including: a first coil including a first core; a second coil spaced apart from the first coil, the second coil including a second core; an intermediate layer disposed in a first region between the first core and the second core and in a second region between the first coil and the second coil; and a magnetic body surrounding the first coil, the second coil, and the intermediate layer, the magnetic body including a first portion that is disposed in the second region and that faces the intermediate layer along a direction perpendicular to a winding direction of the first coil, wherein the intermediate layer has a smaller permeability than that of the magnetic body.

The intermediate layer may be spaced apart from an outer edge of the second region.

The intermediate layer may extend from the first region to a portion of the first core, and the intermediate layer may extend from the first region to a portion of the second core.

The coil electronic component may further include a support disposed in the second region and between the first portion of the magnetic body and the intermediate layer.

The support may be spaced apart from the intermediate layer.

The support may directly contact the intermediate layer.

The coil electronic component according to an embodiment is capable of easily adjusting a coefficient of coupling while securing a high inductance.

The coil electronic component according to another embodiment is capable of preventing the vertically arranged coils from tilting relative to each other and keeping the spacing between the coils constant.

### BRIEF DESCRIPTION OF THE DRAWINGS

FIG. 1 is a schematic perspective view illustrating a coil electronic component according to an embodiment.

FIG. 2 is a schematic plan view illustrating the coil electronic component of FIG. 1.

FIG. 3 is a schematic bottom perspective view illustrating the coil electronic component of FIG. 1.

FIG. 4 is a schematic cross-sectional view taken along line IV-IV′ of FIG. 1.

FIG. 5 is a schematic perspective view illustrating a coil electronic component according to another embodiment.

FIG. 6 is a schematic perspective view illustrating a coil electronic component according to still another embodiment.

FIG. 7 is a schematic cross-sectional view illustrating a coil electronic component according to another embodiment.

FIG. 8 is a schematic perspective view illustrating a coil electronic component according to another embodiment.

FIG. 9 is a cross-sectional view taken along line IX-IX′ of FIG. 8.

### DETAILED DESCRIPTION

Hereinafter, embodiments of the present disclosure will be described in detail with reference to the accompanying drawings so that they can be easily carried out by those of ordinary skill in the art to which the present disclosure pertains. In order to clearly describe the present disclosure, parts irrelevant to the description are omitted in the drawings, and the same or similar components will be denoted by the same reference signs throughout the specification. In the accompanying drawings, some components are exaggerated, omitted, or schematically illustrated, and a size of each component does not entirely reflect the actual size.

The accompanying drawings are provided only to help easily understand the embodiments disclosed in the present specification, and it should be understood that the technical spirit disclosed in the present specification is not limited by the accompanying drawings, and the present disclosure includes all modifications, equivalents, and substitutions falling within the spirit and the technical scope of the present disclosure.

Terms including ordinal numbers such as first and second may be used to describe various components, but these components are not limited by these terms. These terms are used only for the purpose of distinguishing one component from another component.

In addition, when a part such as a layer, a film, a region, or a plate is referred to as being “on” another part, it may be “directly on” the other part or there may be an intervening part therebetween. In contrast, when a part is referred to as being “directly on” another part, there is no intervening part therebetween. In addition, when a part is referred to as being “on” a reference part, it is located on or under the reference part, and does not necessarily mean that it is located “on” the reference part in the opposite direction of gravity.

It should be understood that terms “include”, “have”, and the like used throughout the specification specify the presence of features, numerals, steps, operations, components, parts, or combinations thereof mentioned in the specification, but do not preclude the presence or addition of one or more other features, numerals, steps, operations, components, parts, or combinations thereof. Therefore, when a certain part is referred to as “including” a certain component, this implies the presence of other components, not precluding the presence of other components, unless explicitly stated to the contrary.

In addition, throughout the specification, the phrase “in a plan view” means when a target part is viewed from above, and the phrase “in a cross-sectional view” means when a cross section of a target part as vertically cut is viewed laterally.

In addition, throughout the specification, the expression “connected” means that two or more components are connected to each other not only in a direct manner but also in an indirect manner through another component, means that two or more components are connected to each other not only physically but also electrically, or means that two or more components are integrally formed even though they are referred to by different terms based on their positions and functions.

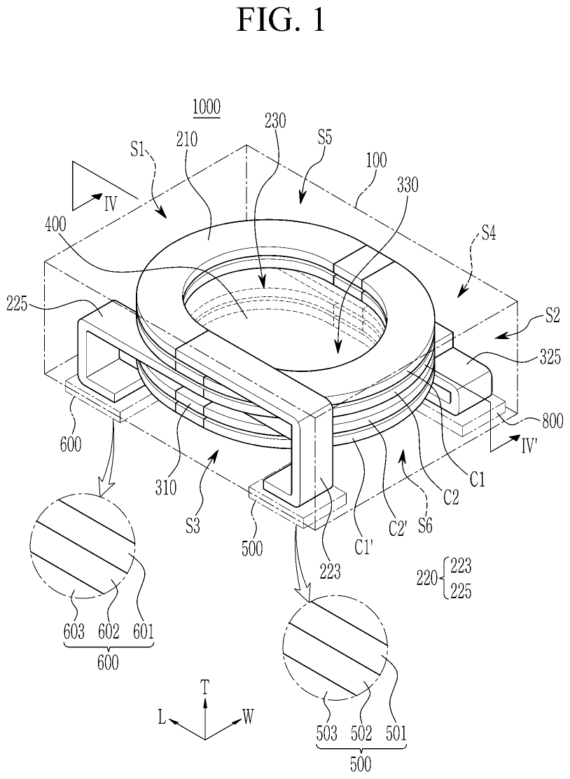

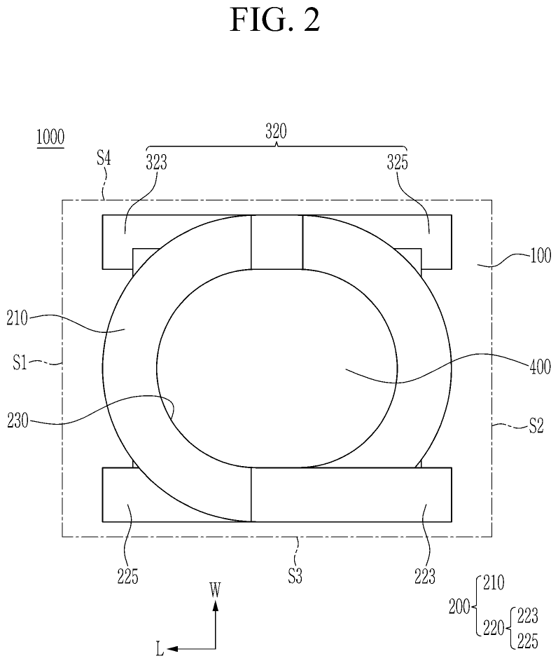

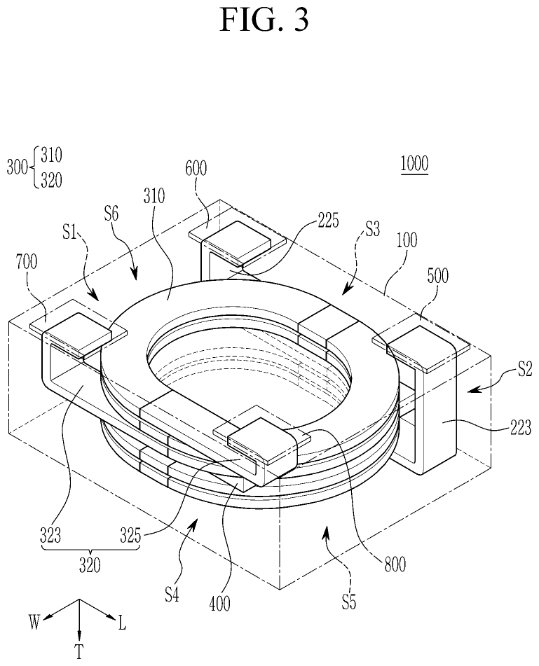

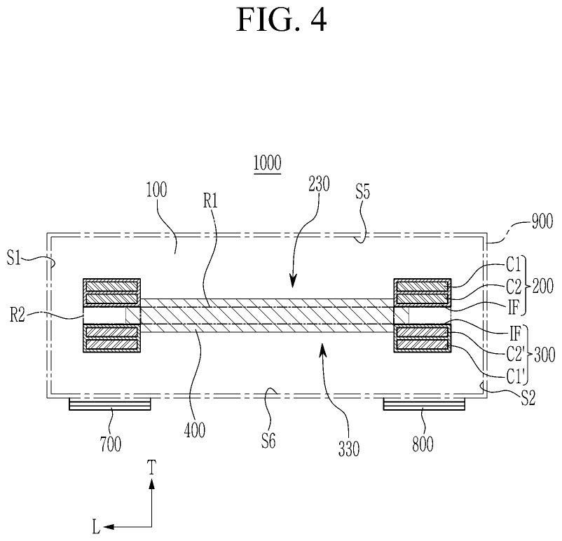

FIG. 1 is a schematic perspective view illustrating a coil electronic component according to an embodiment. FIG. 2 is a schematic plan view illustrating the coil electronic component of FIG. 1. FIG. 3 is a schematic bottom perspective view illustrating the coil electronic component of FIG. 1. FIG. 4 is a schematic cross-sectional view taken along line IV-IV′ of FIG. 1.

Referring to FIGS. 1, 2, 3, and 4, a coil electronic component 1000 according to an embodiment includes a magnetic body 100, a first coil 200, a second coil 300, an intermediate layer 400, a first external electrode 500, a second external electrode 600, a third external electrode 700, and a fourth external electrode 800.

The magnetic body 100 may have a substantially rectangular parallelepiped shape, but the present embodiment is not limited thereto. Due to shrinkage of magnetic powder or the like during sintering, the magnetic body 100 may have a substantially rectangular parallelepiped shape, not a complete rectangular parallelepiped shape. For example, the magnetic body 100 has a substantially rectangular parallelepiped shape, but may have rounded corners or vertices.

In the present embodiment, for convenience of description, two surfaces facing each other in a length direction (L-axis direction) are defined as a first surface S1 and a second surface S2, respectively, two surfaces facing each other in a width direction (W-axis direction) are defined as a third surface S3 and a fourth surface S4, respectively, and two surfaces facing each other in a thickness direction (T-axis direction) are defined as a fifth surface S5 and a sixth surface S6, respectively.

Based on an optical microscope or a scanning electron microscope (SEM) photograph of a cross section taken in the length (L-axis)-thickness (T-axis) directions at the center of the coil electronic component 1000 in the width direction (W-axis direction), a length of the coil electronic component 1000 may refer to a maximum value among lengths of a plurality of line segments each being parallel to the length direction (L-axis direction) and connecting two outermost boundary lines facing each other in the length direction (L-axis direction) of the coil electronic component 1000 shown in the photograph of the cross section described above. Alternatively, the length of the coil electronic component 1000 may refer to a minimum value among lengths of a plurality of line segments each being parallel to the length direction (L-axis direction) and connecting two outermost boundary lines facing each other in the length direction (L-axis direction) of the coil electronic component 1000 shown in the photograph of the cross section described above. Alternatively, the length of the coil electronic component 1000 may refer to an arithmetic average value of lengths of at least two of a plurality of line segments each being parallel to the length direction (L-axis direction) and connecting two outermost boundary lines facing each other in the length direction (L-axis direction) of the coil electronic component 1000 shown in the photograph of the cross section described above.

Based on an optical microscope or a scanning electron microscope (SEM) photograph of a cross section taken in the length (L-axis)-thickness (T-axis) directions at the center of the coil electronic component 1000 in the width direction (W-axis direction), a thickness of the coil electronic component 1000 may refer to a maximum value among lengths of a plurality of line segments each being parallel to the thickness direction (T-axis direction) and connecting two outermost boundary lines facing each other in the thickness direction (T-axis direction) of the coil electronic component 1000 shown in the photograph of the cross section described above. Alternatively, the thickness of the coil electronic component 1000 may refer to a minimum value among lengths of a plurality of line segments each being parallel to the thickness direction (T-axis direction) and connecting two outermost boundary lines facing each other in the thickness direction (T-axis direction) of the coil electronic component 1000 shown in the photograph of the cross section described above. Alternatively, the thickness of the coil electronic component 1000 may refer to an arithmetic average value of lengths of at least two of a plurality of line segments each being parallel to the thickness direction (T-axis direction) and connecting two outermost boundary lines facing each other in the thickness direction (T-axis direction) of the coil electronic component 1000 shown in the photograph of the cross section described above.

Based on an optical microscope or a scanning electron microscope (SEM) photograph of a cross section taken in the length (L-axis)-width (W-axis) directions at the center of the coil electronic component 1000 in the thickness direction (T-axis direction), a width of the coil electronic component 1000 may refer to a maximum value among lengths of a plurality of line segments each being parallel to the width direction (W-axis direction) and connecting two outermost boundary lines facing each other in the width direction (W-axis direction) of the coil electronic component 1000 shown in the photograph of the cross section described above. Alternatively, the width of the coil electronic component 1000 may refer to a minimum value among lengths of a plurality of line segments each being parallel to the width direction (W-axis direction) and connecting two outermost boundary lines facing each other in the width direction (W-axis direction) of the coil electronic component 1000 shown in the photograph of the cross section described above. Alternatively, the width of the coil electronic component 1000 may refer to an arithmetic average value of lengths of at least two of a plurality of line segments each being parallel to the width direction (W-axis direction) and connecting two outermost boundary lines facing each other in the width direction (W-axis direction) of the coil electronic component 1000 shown in the photograph of the cross section described above.

Meanwhile, each of the length, the width, and the thickness of the coil electronic component 1000 may be measured using a micrometer measurement method. In the micrometer measurement method, a zero point is set with a micrometer providing repeatability and reproducibility (Gage R&R), the coil electronic component 1000 according to the present embodiment is inserted between tips of the micrometer, and a measuring lever of the micrometer is turned for the measurement. Meanwhile, when the length of the coil electronic component 1000 is measured using the micrometer measurement method, the length of the coil electronic component 1000 may refer to a single measured value, or may refer to an arithmetic average of a plurality of measured values. This may be equally applied to the measurement of the width and the thickness of the coil electronic component 1000.

The magnetic body 100 constitutes an exterior of the coil electronic component 1000, and has a space where a magnetic path, which is a path through which the magnetic flux induced by the first coil 200 and the magnetic flux induced by the second coil 300 pass, is formed, when current is applied to the first coil 200 through the first external electrode 500 and the second external electrode 600 and current is applied to the second coil 300 through the third external electrode 700 and the fourth external electrode 800.

The magnetic body 100 surrounds and encapsulates the first coil 200, the second coil 300, and the intermediate layer 400, and includes a magnetic material. The magnetic body 100 includes magnetic particles, and an insulating material may be interposed between the magnetic particles.

The magnetic material may include a first metal magnetic powder, a second metal magnetic powder having a particle diameter larger than that of the first metal magnetic powder, and a third metal magnetic powder having a particle diameter larger than that of the second metal magnetic powder. The average particle diameter D₅₀ of the first metal magnetic powder may be 0.1 μm or more and 0.2 μm or less, the average particle diameter D₅₀ of the second metal magnetic powder may be 1 μm or more and 2 μm or less, and the average particle diameter D₅₀ of the third metal magnetic powder may be 25 μm or more and 30 μm or less.

The magnetic particles may be ferrite particles or metal magnetic particles that exhibit magnetic properties.

The ferrite particles may include, for example, at least one of spinel-type ferrites such as Mg—Zn-based ferrites, Mn—Zn-based ferrites, Mn—Mg-based ferrites, Cu—Zn-based ferrites, Mg—Mn—Sr-based ferrites, and Ni—Zn-based ferrites, hexagonal ferrites such as Ba—Zn-based ferrites, Ba—Mg-based ferrites, Ba—Ni-based ferrites, Ba—Co-based ferrites, and Ba—Ni—Co-based ferrites, garnet-type ferrites such as Y-based ferrites, and Li-based ferrites.

The metal magnetic particles may include two or more types of powder particles having different compositions, and may include one or more selected from the group consisting of iron (Fe), silicon (Si), chromium (Cr), cobalt (Co), molybdenum (Mo), aluminum (AI), and niobium (Nb), copper (Cu), and nickel (Ni). For example, the metal magnetic particles may include one or more of pure iron, Fe—Si-based alloys, Fe—Si—Al-based alloys, Fe—Ni-based alloys, Fe—Ni—Mo-based alloys, Fe—Ni—Mo—Cu-based alloys, Fe—Co-based alloys, Fe—Ni—Co-based alloys, Fe—Cr-based alloys, F—Cr—Si-based alloys, Fe—Si—Cu—Nb-based alloys, Fe—Ni—Cr-based alloys, and Fe—Cr—Al-based alloys. Here, different compositions of the metal magnetic particles may mean different contents.

The metal magnetic particles may be amorphous or crystalline. For example, the metal magnetic particles may be Fe—Si—B—Cr-based amorphous alloys, but the present embodiment is not limited thereto. The metal magnetic particles may have an average particle diameter of about 0.1 μm to 30 μm, but are not limited thereto. In the present specification, the average particle diameter may refer to a particle size distribution expressed as D₉₀, D₅₀, etc. The particle size distribution is well known to those skilled in the art as an indicator of what proportion of particles of what size (particle diameter) are contained within a population of particles to be measured. D₅₀ (a particle diameter corresponding to 50% of a cumulative volume of the particle size distribution) refers to an average particle diameter.

The metal magnetic particles may be two or more types of different metal magnetic particles. Here, that the types of the metal magnetic particles are different means that the metal magnetic particles are distinguished from each other in at least one of average particle diameter, composition, component ratio, crystallinity, and shape.

The insulating material may include epoxy, polyimide, liquid crystal polymer, etc. alone or in combination, but is not limited thereto.

The method of forming the magnetic body 100 is not particularly limited. For example, the magnetic body 100 may be formed by placing sheets of a magnetic material on the upper and lower portions of the first coil 200 and the second coil 300 and then compressing and curing the sheets.

The first coil 200 and the second coil 300 are disposed inside the magnetic body 100, exhibiting the characteristics of the coil electronic component. For example, when the coil electronic component 1000 according to the present embodiment is utilized as a power inductor, when current is applied to the first coil 200 and the second coil 300, the coil electronic component may serve to stabilize the power source of an electronic device by storing energy in the form of a magnetic field and maintaining the output voltage.

The first coil 200 and the second coil 300 may be magnetically coupled to each other, thereby comprising a coupled inductor structure.

The first coil 200 and the second coil 300 may be in the form of spirally wound metal (e.g., copper (Cu) or silver (Ag)) wire with a surface coated with an insulating material. That is, the first coil 200 and the second coil 300 may be wound coils. Each of the first coil 200 and the second coil 300 are not limited to a single wire, but may comprise a twisted wire or two or more wires.

The first coil 200 and the second coil 300 may be circular coils, but are not limited thereto. For example, the first coil 200 and the second coil 300 may be various known coils such as rectangular coils.

A cross section of an individual wire of each of the first coil 200 and the second coil 300 may have various known shapes such as a rectangular shape, a circular shape, and an oval shape.

The first coil 200 and the second coil 300 may have a plurality of turns and may be edgewise coils.

For example, the first coil 200 may have an outermost turn coil C1 and an innermost turn coil C2 sequentially in a direction from the fifth surface S5 to the sixth surface S6 of the coil electronic component 1000. Meanwhile, although not illustrated, at least one intermediate turn coil may be disposed between the outermost turn coil C1 and the innermost turn coil C2.

Similarly, the second coil 300 may have an outermost turn coil C1′ and an innermost turn coil C2′ sequentially in a direction from the sixth surface S6 to the fifth surface S5 of the coil electronic component 1000. Meanwhile, although not illustrated, at least one intermediate turn coil may be disposed between the outermost turn coil C1′ and the innermost turn coil C2′.

Insulating films IF may be disposed along the respective surfaces of the plurality of turns of the first coil 200 and the second coil 300. The insulating film IF is for protecting and insulating the plurality of turns of the first coil 200 and the second coil 300, and may contain a well-known insulating material such as parylene. The insulating film IF may include any insulating material, and the insulating material of the insulating film IF is not particularly limited. For example, the insulating film IF may be a polyurethane resin, a polyester resin, an epoxy resin, or a polyamideimide resin. The insulating film IF may be formed by a vapor deposition method or the like, but are not limited thereto.

Meanwhile, the shapes of the first coil 200 and the second coil 300 are not limited to those described above and may have various well-known shapes. For example, the first coil 200 may have an outermost turn coil, one or more intermediate turn coils, and an innermost turn coil sequentially in an inward direction from the outer surface of the magnetic body 100. Similarly, the second coil 300 may have an outermost turn coil, one or more intermediate turn coils, and an innermost turn coil sequentially in an inward direction from the outer surface of the magnetic body 100.

The first coil 200 may include a winding portion 210 and lead-out portions 220.

The winding portion 210 is a portion where the metal wire comprises at least one turn.

The lead-out portions 220 extend from both ends of the winding portion 210, respectively, each of the lead-out portions 220 being exposed to the sixth surface S6 of the magnetic body 100. The lead-out portions 220 include a first lead-out portion 223 and a second lead-out portion 225. The first lead-out portion 223 extends from one end of the winding portion 210 and is exposed to the sixth surface S6 of the magnetic body 100, and the second lead-out portion 225 extends from the other end of the winding portion 210 and is exposed to the sixth surface S6 of the magnetic body 100. The locations where the first lead-out portion 223 and the second lead-out portion 225 are exposed to the sixth surface S6 of the magnetic body 100 may be spaced apart from each other in the length direction (L-axis direction), but are not limited thereto.

The second coil 300 may include a winding portion 310 and lead-out portions 320.

The winding portion 310 is a portion where the metal wire comprises at least one turn.

The lead-out portions 320 extend from both ends of the winding portion 310, respectively, each of the lead-out portions 320 being exposed to the sixth surface S6 of the magnetic body 100. The lead-out portions 320 include a third lead-out portion 323 and a fourth lead-out portion 325. The third lead-out portion 323 extends from one end of the winding portion 310 and is exposed to the sixth surface S6 of the magnetic body 100, and the fourth lead-out portion 325 extends from the other end of the winding portion 310 to expose to the sixth surface S6 of the magnetic body 100. The locations where the third lead-out portion 323 and the fourth lead-out portion 325 are exposed to the sixth surface S6 of the magnetic body 100 may be spaced apart from each other in the length direction (L-axis direction), but are not limited thereto.

Although it has been described above that both the lead-out portions 220 of the first coil 200 and the lead-out portions 320 of the second coil 300 are exposed to the sixth surface S6 of the magnetic body 100, but the present embodiment is not limited thereto. For example, the lead-out portions 220 of the first coil 200 may be exposed to the third surface S3 of the magnetic body 100, and the lead-out portions 320 of the second coil 300 may be exposed to the fourth surface S4 of the magnetic body 100.

The intermediate layer 400 is disposed between the first coil 200 and the second coil 300. For example, the intermediate layer 400 may be in contact with the first coil 200 and the second coil 300.

The intermediate layer 400 may have a rectangular shape when viewed in the thickness direction (T-axis direction), but is not limited thereto. The intermediate layer 400 may have a shape similar to, for example, the winding portion 210 of the first coil 200 or the winding portion 310 of the second coil 300.

The intermediate layer 400 may be disposed to extend from a first region R1 between a first core 230 of the first coil 200 and a second core 330 of the second coil 300 to a portion of a second region R2 between the first coil 200 and the second coil 300.

The first core 230 may be a region where a first hollow space of the first coil 200 is at least partially filled with the magnetic body 100, and the second core 330 may be a region where a second hollow space of the second coil 300 is at least partially filled with the magnetic body 100. That is, the magnetic body 100 filling the first hollow space of the first coil 200 may comprise the first core around which the first coil 200 is wound, and the magnetic body 100 filling the second hollow space of the second coil 300 may comprise the second core around which the second coil 300 is wound.

A thickness of the intermediate layer 400 in the first region R1 may be the same as a thickness of the intermediate layer 400 in the second region R2.

The thickness of the intermediate layer 400 is measured based on an optical microscope or a scanning electron microscope (SEM) photograph of a cross section taken in the length (L-axis)-thickness (T-axis) directions at the center of the coil electronic component 1000 in the width direction (W-axis direction). The thickness of the intermediate layer 400 may be an arithmetic average value of thicknesses of the intermediate layer 400 at five equally spaced points of the intermediate layer 400 of the coil electronic component 1000 shown in the photograph of the cross section described above. Other methods and/or tools appreciated by one of ordinary skill in the art, even if not described in the present disclosure, may also be used.

The thickness of the intermediate layer 400 in the first region R1 may be different from the thickness of the intermediate layer 400 in the second region R2. For example, the intermediate layer 400 may extend from the first region R1 to a portion of the first core 230, or extend from the first region R1 to a portion of the second core 330. On the other hand, the intermediate layer 400 may extend from the first region R1 to a portion of the first core 230 and a portion of the second core 330.

In a case where the intermediate layer 400 extends from the first region R1 to a portion of the first core 230, the portion of the first core 230 may be filled with the intermediate layer 400 and the remaining portion of the first core 230 may be filled with the magnetic body 100. In addition, in a case where the intermediate layer 400 extends from the first region R1 to a portion of the second core 330, the portion of the second core 330 may be filled with the intermediate layer 400 and the remaining portion of the second core 330 may be filled with the magnetic body 100. In this case, the magnetic body 100 and the intermediate layer 400 filling the first hollow space of the first coil 200 may comprise the first core 230 around which the first coil 200 is wound, and the magnetic body 100 and the intermediate layer 400 filling the second hollow space of the second coil 300 may comprise the second core 330 around which the second coil 300 is wound.

Since the intermediate layer 400 may be disposed to extend from the first region R1 to a portion of the second region R2, the intermediate layer 400 may not be disposed throughout the entirety of the second region R2.

For example, the second region R2 may have an outer edge close to the outer surface of the coil electronic component 1000 and an inner edge close to the inner side of the coil electronic component 1000. In other words, the second region R2 may have an inner edge close to the first core 230 and the second core 330 and an outer edge away from the first core 230 and the second core 330. The intermediate layer 400 extends from the inner edge toward the outer edge of the second region R2 but may be spaced apart from the outer edge.

The intermediate layer 400 may fill a portion of the second region R2, in contact with the innermost turn coil C2 of the first coil 200 and the innermost turn coil C2′ of the second coil 300 in the second region R2. The remaining portion of the second region R2, which is not filled with the intermediate layer 400, may be filled with the magnetic body 100. That is, the magnetic body 100 may be disposed from the outer edge of the second region R2 to the intermediate layer 400.

Meanwhile, the intermediate layer 400 may include a magnetic material and affect the magnetic coupling properties of the first coil 200 and the second coil 300. The intermediate layer 400 may include magnetic particles, and an insulating material may be interposed between the magnetic particles.

The magnetic material may include a first metal magnetic powder, a second metal magnetic powder having a particle diameter larger than that of the first metal magnetic powder, and a third metal magnetic powder having a particle diameter larger than that of the second metal magnetic powder. The average particle diameter D₅₀ of the first metal magnetic powder may be 0.1 μm or more and 0.2 μm or less, the average particle diameter D₅₀ of the second metal magnetic powder may be 1 μm or more and 2 μm or less, and the average particle diameter D₅₀ of the third metal magnetic powder may be 25 μm or more and 30 μm or less.

The magnetic particles may be ferrite particles or metal magnetic particles that exhibit magnetic properties.

The ferrite particles may include, for example, at least one of spinel-type ferrites such as Mg—Zn-based ferrites, Mn—Zn-based ferrites, Mn—Mg-based ferrites, Cu—Zn-based ferrites, Mg—Mn—Sr-based ferrites, and Ni—Zn-based ferrites, hexagonal ferrites such as Ba—Zn-based ferrites, Ba—Mg-based ferrites, Ba—Ni-based ferrites, Ba—Co-based ferrites, and Ba—Ni—Co-based ferrites, garnet-type ferrites such as Y-based ferrites, and Li-based ferrites.

The metal magnetic particles may include two or more types of powder particles having different compositions, and may include one or more selected from the group consisting of iron (Fe), silicon (Si), chromium (Cr), cobalt (Co), molybdenum (Mo), aluminum (AI), and niobium (Nb), copper (Cu), and nickel (Ni). For example, the metal magnetic particles may include one or more of pure iron, Fe—Si-based alloys, Fe—Si—Al-based alloys, Fe—Ni-based alloys, Fe—Ni—Mo-based alloys, Fe—Ni—Mo—Cu-based alloys, Fe—Co-based alloys, Fe—Ni—Co-based alloys, Fe—Cr-based alloys, Fe—Cr—Si-based alloys, Fe—Si—Cu—Nb-based alloys, Fe—Ni—Cr-based alloys, and Fe—Cr—Al-based alloys. Here, different compositions of the metal magnetic particles may mean different contents.

The metal magnetic particles may be amorphous or crystalline. For example, the metal magnetic particles may be Fe—Si—B—Cr-based amorphous alloys, but the present embodiment is not limited thereto. The metal magnetic particles may have an average particle diameter of about 0.1 μm to 30 μm, but are not limited thereto. In the present specification, the average particle diameter may refer to a particle size distribution expressed as D₉₀, D₅₀, etc. The particle size distribution is well known to those skilled in the art as an indicator of what proportion of particles of what size (particle diameter) are contained within a population of particles to be measured. D₅₀ (a particle diameter corresponding to 50% of a cumulative volume of the particle size distribution) refers to an average particle diameter.

The metal magnetic particles may be two or more types of different metal magnetic particles. Here, that the types of the metal magnetic particles are different means that the metal magnetic particles are distinguished from each other in at least one of average particle diameter, composition, component ratio, crystallinity, and shape.

The insulating material may include epoxy, polyimide, liquid crystal polymer, etc. alone or in combination, but is not limited thereto.

The intermediate layer 400 includes the above-mentioned material, but the intermediate layer 400 may have a smaller permeability than that of the magnetic body 100. Furthermore, the permeability of the magnetic body 100 and the permeability of the intermediate layer 400 may be appropriately set to adjust a coefficient of coupling (K) between the first coil 200 and the second coil 300. As used herein, the term “permeability” refers to the amount of magnetization produced in a material in response to an applied magnetic field. The permeability may be measured by the Gouy method. Other methods and/or tools appreciated by one of ordinary skill in the art, even if not described in the present disclosure, may also be used.

For example, as a method of adjusting the permeability of the magnetic body 100 and the permeability of the intermediate layer 400, a volume fraction of first magnetic particles included in the magnetic body 100 and a volume fraction of second magnetic particles included in the intermediate layer 400 may be set differently. Here, the volume fraction of magnetic particles refers to a ratio of the volume of the first magnetic particles to the volume of the magnetic body 100 or a ratio of the volume of the second magnetic particles to the volume of the intermediate layer 400. In order to adjust the relative permeabilities of the magnetic body 100 and the intermediate layer 400 based on the volume fractions of the first magnetic particles and the second magnetic particles, the first magnetic particles and the second magnetic particles may be realized as the same material, for example, a metal alloy of the same composition. Meanwhile, as a method of adjusting the permeability of the magnetic body 100 and the permeability of the intermediate layer 400, an area fraction of the first magnetic particles included in the magnetic body 100 and an area fraction of the second magnetic particles included in the intermediate layer 400 may be set differently when confirmed in cross-section. Here, the area fraction of magnetic particles refers to a ratio of the cross-sectional area of the first magnetic particles to the cross-sectional area of the magnetic body 100 or a ratio of the cross-sectional area of the second magnetic particles to the cross-sectional area of the intermediate layer 400.

When the permeability of the intermediate layer 400 is smaller than the permeability of the magnetic body 100, the volume fraction of the second magnetic particles included in the intermediate layer 400 may be smaller than the volume fraction of the first magnetic particles included in the magnetic body 100. If the permeability of the intermediate layer 400 is smaller than the permeability of the magnetic body 100, the coefficient of coupling between the first coil 200 and the second coil 300 may relatively increase. Here, a relative increase in coefficient of coupling means that the coefficient of coupling becomes larger compared with the case where the permeability of the intermediate layer 400 and the permeability of the magnetic body 100 are the same. When the permeability of the intermediate layer 400 is relatively small, an amount of magnetic flux flowing through the intermediate layer 400 is relatively small, and a mutual inductance caused by the magnetic flux shared by the first coil 200 and the second coil 300 becomes larger. Here, the magnetic flux flowing through the intermediate layer 400 may be understood as magnetic flux flowing through the intermediate layer 400 in the length direction (L-axis direction) in FIG. 4.

As a result, the mutual inductance between the first coil 200 and the second coil 300 becomes larger and the leakage inductance formed only in the first coil 200 or the second coil 300 becomes smaller, so the coefficient of coupling between the first coil 200 and the second coil 300 becomes larger.

The first external electrode 500 and the second external electrode 600 are disposed outside the magnetic body 100 and electrically connected to the first coil 200.

The first external electrode 500 is disposed on the sixth surface S6 of the magnetic body 100, and the first lead-out portion 223 of the first coil 200 is exposed from the sixth surface S6 of the magnetic body 100 and connected to the first external electrode 500.

The second external electrode 600 is disposed on the sixth surface S6 of the magnetic body 100, and the second lead-out portion 225 of the first coil 200 is exposed from the sixth surface S6 of the magnetic body 100 and connected to the second external electrode 600.

The first external electrode 500 and the second external electrode 600 may each be made of a conductive material such as copper (Cu), aluminum (AI), silver (Ag), tin (Sn), gold (Au), nickel (Ni), lead (Pb), chromium (Cr), titanium (Ti), or an alloy thereof, but is not limited thereto.

The first external electrode 500 and the second external electrode 600 may include a plurality of metal layers formed by plating conductive metals.

Referring to the right circle of FIG. 1, the first external electrode 500 may include a first metal layer 501, a second metal layer 502, and a third metal layer 503.

The first metal layer 501 is a plating layer that is in contact with the first lead-out portion 223 of the first coil 200 and the outer surface of the magnetic body 100, and may include copper (Cu). The second metal layer 502 is a plating layer that covers the first metal layer 501, and may include nickel (Ni). The third metal layer 503 is a plating layer that covers the second metal layer 502, and may include tin (Sn). However, the present embodiment is not limited to such a three-layer structure, and a two-layer structure with only one plating layer added onto the first metal layer 501 is also possible.

Referring to the left circle of FIG. 1, the second external electrode 600 may include a first metal layer 601, a second metal layer 602, and a third metal layer 603.

The first metal layer 601 is a plating layer that is in contact with the second lead-out portion 225 of the first coil 200 and the outer surface of the magnetic body 100, and may include copper (Cu). The second metal layer 602 is a plating layer that covers the first metal layer 601, and may include nickel (Ni). The third metal layer 603 is a plating layer that covers the second metal layer 602, and may include tin (Sn). However, the present embodiment is not limited to such a three-layer structure, and a two-layer structure with only one plating layer added onto the first metal layer 601 is also possible.

In this manner, the first external electrode 500 and the second external electrode 600 may each include nickel (Ni), copper (Cu), palladium (Pd), gold (Au), or an alloy thereof, and may include a plurality of plating layers. For example, the first external electrode 500 and the second external electrode 600 may each be made of combinations such as nickel (Ni) layer, copper (Cu) layer, nickel/copper (Ni/Cu) layer, palladium/nickel (Pd/Ni) layer, palladium/nickel/copper (Pd/Ni/Cu) layer, and copper/nickel/copper (Cu/Ni/Cu) layer.

In some cases, the outermost layer may be made of tin (Sn). Since the tin plating layer has a relatively low melting point, it can improve the ease of substrate mounting of the first external electrode 500 and the second external electrode 600.

In general, the tin plating layer may be bonded to an electrode pad on the substrate through a solder containing tin (Sn)-copper (Cu)-silver (Ag) alloy paste. That is, the tin plating layer may be melt and bond with the solder during a heat treatment (reflow) process.

The third external electrode 700 and the fourth external electrode 800 are disposed outside the magnetic body 100 and electrically connected to the second coil 300.

The third external electrode 700 is disposed on the sixth surface S6 of the magnetic body 100, and the third lead-out portion 323 of the second coil 300 is exposed from the sixth surface S6 of the magnetic body 100 and connected to the third external electrode 700.

The fourth external electrode 800 is disposed on the sixth surface S6 of the magnetic body 100, and the fourth lead-out portion 325 of the second coil 300 is exposed from the sixth surface S6 of the magnetic body 100 and connected to the fourth external electrode 800.

Since the structures and components of the third external electrode 700 and the fourth external electrode 800 are the same as those of the first external electrode 500 and the second external electrode 600 described above, a redundant description thereof will be omitted.

Meanwhile, an insulating layer 900 may be disposed on the magnetic body 100 of the coil electronic component 1000 according to the present embodiment, except for the areas where the first external electrode 500, the second external electrode 600, the third external electrode 700, and the fourth external electrode 800 are disposed. Unlike this, an insulating layer may be present between the portion where the first lead-out portion 223 of the first coil 200 is exposed, the portion where the second lead-out portion 225 of the first coil 200 is exposed, the portion where the third lead-out portion 323 of the second coil 300 is exposed, and the portion where the fourth lead-out portion 325 of the second coil 300 is exposed on the sixth surface S6 of the magnetic body 100. In this case, the first external electrode 500, the second external electrode 600, the third external electrode 700, and the fourth external electrode 800 may cover portions of the insulating layer.

As described above, the insulating layer 900 may be disposed on at least a portion of the first surface S1, the second surface S2, the third surface S3, the fourth surface S4, the fifth surface S5, and the sixth surface S6 of the magnetic body 100 to prevent electrical short circuits between other electronic components and the external electrodes 500, 600, 700, and 800.

The insulating layer 900 may be utilized as a resist when forming the external electrodes 500, 600, 700, and 800 by electroplating, but is not limited thereto.

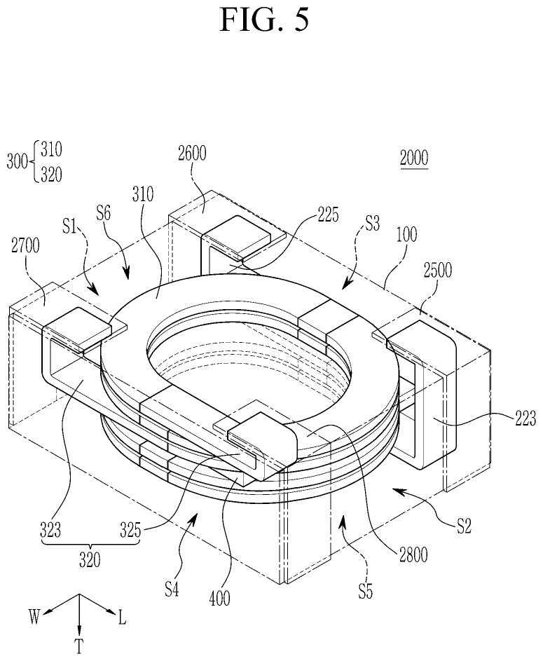

FIG. 5 is a schematic perspective view illustrating a coil electronic component according to another embodiment.

Referring to FIG. 5, a first external electrode 2500 of a coil electronic component 2000 according to another embodiment may be connected to the first lead-out portion 223 of the first coil 200 on the sixth surface S6 of the magnetic body 100 and extend to the second surface S2 of the magnetic body 100. In addition, a second external electrode 2600 may be connected to the second lead-out portion 225 of the first coil 200 on the sixth surface S6 of the magnetic body 100 and extend to the first surface S1 of the magnetic body 100.

A third external electrode 2700 may be connected to the third lead-out portion 323 of the second coil 300 on the sixth surface S6 of the magnetic body 100 and extend to the first surface S1 of the magnetic body 100. In addition, a fourth external electrode 2800 may be connected to the fourth lead-out portion 325 of the second coil 300 on the sixth surface S6 of the magnetic body 100 and extend to the second surface S2 of the magnetic body 100.

Since the components other than the above-described components are the same as the components of the coil electronic component illustrated in FIG. 1, a redundant description thereof will be omitted.

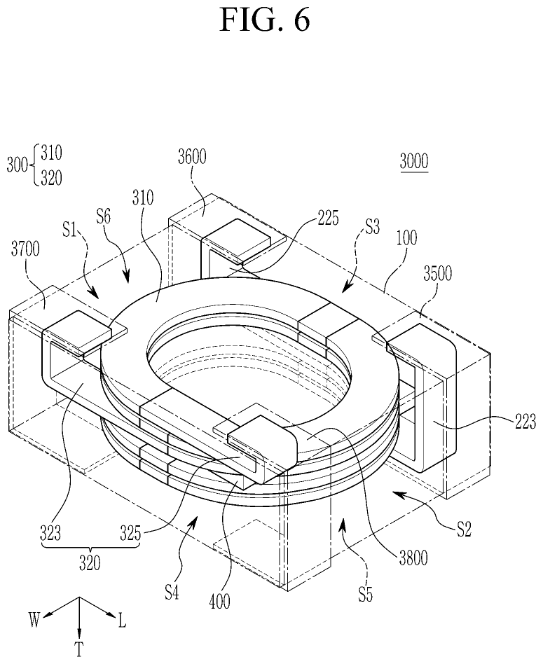

FIG. 6 is a schematic perspective view illustrating a coil electronic component according to another embodiment.

Referring to FIG. 6, a first external electrode 3500 of a coil electronic component 3000 according to another embodiment may be connected to the first lead-out portion 223 of the first coil 200 on the sixth surface S6 of the magnetic body 100 and extend to the second surface S2 and the fifth surface S5 of the magnetic body 100. In addition, a second external electrode 3600 may be connected to the second lead-out portion 225 of the first coil 200 on the sixth surface S6 of the magnetic body 100 and extend to the first surface S1 and the fifth surface S5 of the magnetic body 100.

A third external electrode 3700 may be connected to the third lead-out portion 323 of the second coil 300 on the sixth surface S6 of the magnetic body 100 and extend to the first surface S1 and the fifth surface S5 of the magnetic body 100. In addition, a fourth external electrode 3800 may be connected to the fourth lead-out portion 325 of the second coil 300 on the sixth surface S6 of the magnetic body 100 and extend to the second surface S2 and the fifth surface S5 of the magnetic body 100.

Since the components other than the above-described components are the same as the components of the coil electronic component illustrated in FIG. 1, a redundant description thereof will be omitted.

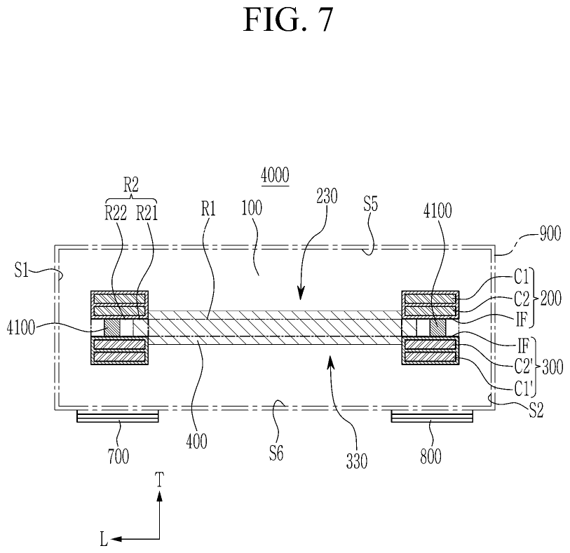

FIG. 7 is a schematic cross-sectional view illustrating a coil electronic component according to another embodiment.

Referring to FIG. 7, a coil electronic component 4000 according to another embodiment may include a magnetic body 100, a first coil 200, a second coil 300, an intermediate layer 400, and a support 4100.

The intermediate layer 400 is disposed between the first coil 200 and the second coil 300. For example, the intermediate layer 400 may be in contact with the first coil 200 and the second coil 300.

The intermediate layer 400 may extend from the first region R1 between the first core 230 of the first coil 200 and the second core 330 of the second coil 300 to a portion of the second region R2 between the first coil 200 and the second coil 300.

The second region R2 may include an inner region R21 and an outer region R22.

The inner region R21 is a region where the intermediate layer 400 is disposed and is a region close to the first core 230 and the second core 330.

The outer region R22 is a region in contact with the inner region R21 and where the magnetic body 100 is disposed, and is a region away from the first core 230 and the second core 330.

A support 4100 may be disposed within the second region R2 and in contact with the first coil 200 and the second coil 300. Since the support 4100 is in contact with both the first coil 200 and the second coil 300, the support 4100 may prevent the first coil 200 and the second coil 300 from tilting relative to each other. That is, the spacing between the first coil 200 and the second coil 300 may be kept constant by the support 4100.

Meanwhile, the support 4100 may be spaced apart from the intermediate layer 400 or may be in contact with the intermediate layer 400.

The support 4100 may be made of or include, for example, a magnetic material, an epoxy or a non-magnetic material. In a case where the support 4100 is made of a magnetic material, the permeability of the support 4100 may be larger than the permeability of the intermediate layer 400 and equal to or smaller than the permeability of the magnetic body 100.

Since the components other than the above-described components are the same as the components of the coil electronic component illustrated in FIG. 1, a redundant description thereof will be omitted.

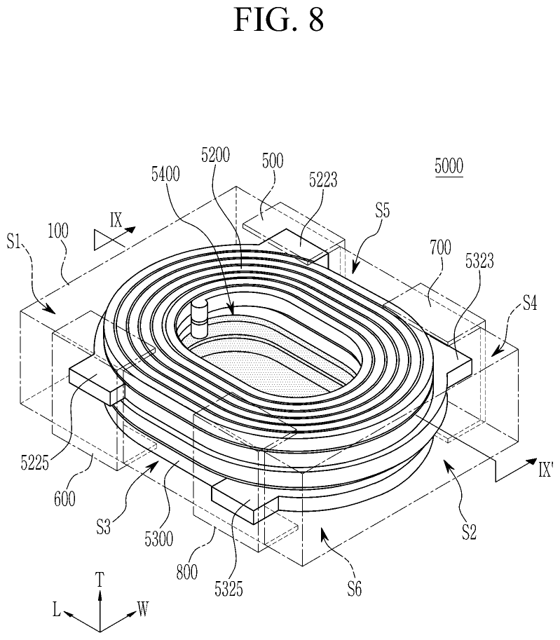

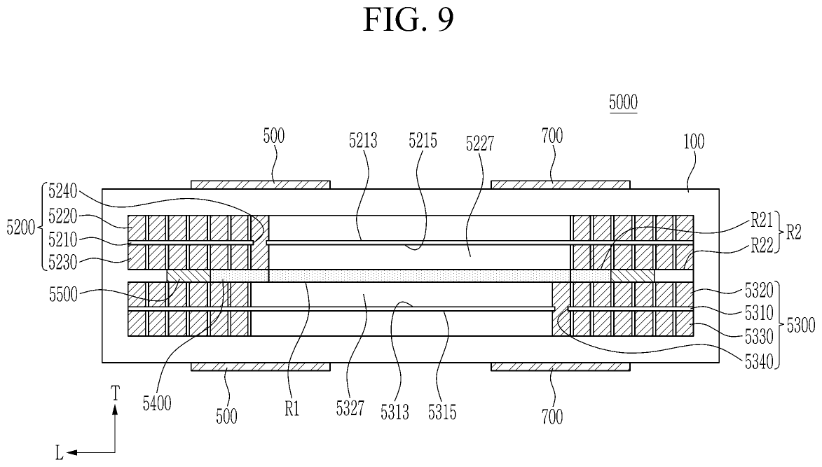

FIG. 8 is a schematic perspective view illustrating a coil electronic component according to another embodiment. FIG. 9 is a cross-sectional view taken along line IX-IX′ of FIG. 8.

Referring to FIGS. 8 and 9, a coil electronic component 5000 according to another embodiment may include a magnetic body 100, a first coil 5200, a second coil 5300, an intermediate layer 5400, a first external electrode 500, a second external electrode 600, a third external electrode 700, a fourth external electrode 800, and a support 5500.

The first coil 5200 may include a first support member 5210, a first coil pattern 5220, a second coil pattern 5230, and a first via 5240.

The first support member 5210 may have a first surface 5213 and a second surface 5215 facing each other, and may be made of an insulating material.

The first coil pattern 5220 may be disposed on the first surface 5213 of the first support member 5210, and the second coil pattern 5230 may be disposed on the second surface 5215 of the first support member 5210. The first coil pattern 5220 and the second coil pattern 5230 may be formed using a plating process used in the art, such as pattern plating, anisotropic plating, isotropic plating, or the like, and may also be formed into a multilayer structure using a plurality of these processes.

The first via 5240 may pass through the first support member 5210 to connect the first coil pattern 5220 and the second coil pattern 5230.

The second coil 5300 may include a second support member 5310, a third coil pattern 5320, a fourth coil pattern 5330, and a second via 5340.

The second support member 5310 may have a third surface 5313 and a fourth surface 5315 facing each other, and may be made of an insulating material.

The third coil pattern 5320 may be disposed on the third surface 5313 of the second support member 5310, and the fourth coil pattern 5330 may be disposed on the fourth surface 5315 of the second support member 5310. The third coil pattern 5320 and the fourth coil pattern 5330 may be formed using a plating process used in the art, such as pattern plating, anisotropic plating, isotropic plating method, or the like, and may also be formed into a multilayer structure using a plurality of these processes.

The second via 5340 may pass through the second support member 5310 to connect the third coil pattern 5320 and the fourth coil pattern 5330.

The intermediate layer 5400 is disposed between the first coil 5200 and the second coil 5300.

The intermediate layer 5400 may extend from a first region R1 between the first core 5227 of the first coil 5200 and the second core 5327 of the second coil 5300 to a portion of a second region R2 between the first coil 5200 and the second coil 5300.

The second region R2 may include an inner region R21 and an outer region R22.

The inner region R21 is a region where the intermediate layer 5400 is disposed and is a region close to the first core 5227 and the second core 5327.

The outer region R22 is a region in contact with the inner region R21 and where the magnetic body 100 is disposed, and is a region away from the first core 5227 and the second core 5327.

The support 5500 may be disposed within the second region R2 and in contact with the first coil 5200 and the second coil 5300. Since the support 5500 is in contact with both the first coil 5200 and the second coil 5300, the support 5500 may prevent the first coil 5200 and the second coil 5300 from tilting relative to each other. That is, the spacing between the first coil 5200 and the second coil 5300 may be kept constant by the support 5500.

Meanwhile, the intermediate layer 5400 may include a magnetic material and affect the magnetic coupling properties of the first coil 5200 and the second coil 5300. The intermediate layer 400 may include magnetic particles, and an insulating material may be interposed between the magnetic particles.

The intermediate layer 5400 may have a smaller permeability than that of the magnetic body 100. Furthermore, the permeability of the magnetic body 100 and the permeability of the intermediate layer 5400 may be appropriately set to adjust a coefficient of coupling (K) between the first coil 5200 and the second coil 5300.

The first external electrode 500 and the second external electrode 600 are disposed outside the magnetic body 100 and electrically connected to the first coil 5200.

A first lead-out portion 5223 of the first coil 5200 is exposed from the fourth surface S4 of the magnetic body 100 and connected to the first external electrode 500. The first external electrode 500 may extend from the fourth surface S4 to the fifth surface S5 and the sixth surface S6 of the magnetic body. In addition, a second lead-out portion 5225 of the first coil 5200 is exposed from the third surface S3 of the magnetic body 100 and connected to the second external electrode 600. The second external electrode 600 may extend from the third surface S3 to the fifth surface S5 and the sixth surface S6 of the magnetic body.

The third external electrode 700 and the fourth external electrode 800 are disposed outside the magnetic body 100 and electrically connected to the second coil 5300.

A first lead-out portion 5323 of the second coil 5300 is exposed from the fourth surface S4 of the magnetic body 100 and connected to the third external electrode 700. The third external electrode 700 may extend from the fourth surface S4 to the fifth surface S5 and the sixth surface S6 of the magnetic body. In addition, a second lead-out portion 5325 of the second coil 5300 is exposed from the third surface S3 of the magnetic body 100 and connected to the fourth external electrode 800. The fourth external electrode 800 may extend from the third surface S3 to the fifth surface S5 and the sixth surface S6 of the magnetic body.

Since the components other than the above-described components are the same as the components of the coil electronic component illustrated in FIG. 1, a redundant description thereof will be omitted.

Although the embodiments of the present disclosure have been described above, the present disclosure is not limited thereto, and various modifications may be made within the scope of the claims, the specification, and the accompanying drawings, which also fall within the scope of the present disclosure.

What is claimed is:

1. A coil electronic component comprising:
a first coil including a first core;
a second coil spaced apart from the first coil, the second coil including a second core;
an intermediate layer disposed from a first region between the first core and the second core to a second region between the first coil and the second coil; and
a magnetic body surrounding the first coil, the second coil, and the intermediate layer,
wherein the intermediate layer has a smaller permeability than that of the magnetic body.

2. The coil electronic component of claim 1, wherein
the intermediate layer is in contact with the first coil and the second coil.

3. The coil electronic component of claim 2, wherein
the intermediate layer is spaced apart from an outer edge of the second region.

4. The coil electronic component of claim 1, wherein
a thickness of the intermediate layer in the first region is the same as a thickness of the intermediate layer in the second region.

5. The coil electronic component of claim 1, wherein
the intermediate layer extends from the first region to a portion of the first core.

6. The coil electronic component of claim 1, wherein
the intermediate layer extends from the first region to a portion of the second core.

7. The coil electronic component of claim 1, wherein
the intermediate layer extends from the first region to a portion of the first core, and
the intermediate layer extends from the first region to a portion of the second core.

8. The coil electronic component of claim 1, wherein
the second region includes an inner region and an outer region in contact with the inner region,
the intermediate layer is disposed in the inner region, and
the magnetic body is disposed in the outer region.

9. The coil electronic component of claim 1, further comprising:
a support disposed in the second region and in contact with the first coil and the second coil.

10. The coil electronic component of claim 9, wherein
the support is spaced apart from the intermediate layer.

11. The coil electronic component of claim 9, wherein
the support is in contact with the intermediate layer.

12. The coil electronic component of claim 9, wherein
the support includes a magnetic material, an epoxy, or a non-magnetic material.

13. The coil electronic component of claim 1, wherein the first coil further includes a first lead-out portion and a second lead-out portion, the second coil further includes a third lead-out portion and a fourth lead-out portion, and the coil electronic component further comprises:
a first external electrode disposed outside the magnetic body and connected to the first lead-out portion;
a second external electrode disposed outside the magnetic body and connected to the second lead-out portion;
a third external electrode disposed outside the magnetic body and connected to the third lead-out portion; and
a fourth external electrode disposed outside the magnetic body and connected to the fourth lead-out portion.

14. The coil electronic component of claim 1, wherein
the first coil further includes a first wound coil, and
the second coil further includes a second wound coil.

15. The coil electronic component of claim 1, wherein
the first coil further includes:
a first support member having a first surface and a second surface facing each other;
a first coil pattern disposed on the first surface of the first support member;
a second coil pattern disposed on the second surface of the first support member; and
a first via passing through the first support member to connect the first coil pattern and the second coil pattern, and
the second coil includes:
a second support member having a third surface and a fourth surface facing each other;
a third coil pattern disposed on the third surface of the second support member;
a fourth coil pattern disposed on the fourth surface of the second support member; and
a second via passing through the second support member to connect the third coil pattern and the fourth coil pattern.

16. The coil electronic component of claim 1, wherein
the intermediate layer is disposed to extend to a portion of the second region.

17. The coil electronic component of claim 1, further comprising an insulating film disposed on a surface of the first coil and a surface of the second coil.

18. A coil electronic component comprising:
a first coil including a first core;
a second coil spaced apart from the first coil, the second coil including a second core;
an intermediate layer disposed in a first region between the first core and the second core and in a second region between the first coil and the second coil; and
a magnetic body surrounding the first coil, the second coil, and the intermediate layer, the magnetic body including a first portion that is disposed in the second region and that faces the intermediate layer along a direction perpendicular to a winding direction of the first coil,
wherein the intermediate layer has a smaller permeability than that of the magnetic body.

19. The coil electronic component of claim 18, wherein
the intermediate layer is spaced apart from an outer edge of the second region.

20. The coil electronic component of claim 19, wherein
the intermediate layer extends from the first region to a portion of the first core, and
the intermediate layer extends from the first region to a portion of the second core.

21. The coil electronic component of claim 20, further comprising:
a support disposed in the second region and between the first portion of the magnetic body and the intermediate layer.

22. The coil electronic component of claim 21, wherein
the support is spaced apart from the intermediate layer.

23. The coil electronic component of claim 21, wherein
the support directly contacts the intermediate layer.
